(19) United States
(12) Patent Application Publication
(10) Pub. No.: US 2025/0359514 A1
(43) Pub. Date: Nov. 27, 2025

(54) HARVESTING APPLIANCE HAVING A REEL PROTECTED AGAINST OVERLOAD

(71) Applicant: Carl Geringhoff GmbH & Co. Kommanditgesellschaft, Ahlen (DE)

(72) Inventors: Michael Pokriefke, Hude (DE); Steffen Sudhues, Ahlen (DE)

(73) Assignee: Carl Geringhoff GmbH & Co. Kommanditgesellschaft, Ahlen (DE)

(21) Appl. No.: 19/214,512

(22) Filed: May 21, 2025

(30) Foreign Application Priority Data
May 23, 2024 (DE) 102024114532.3

(51) Int. Cl. A01D 57/03; A01D 57/04

(52) U.S. Cl. CPC A01D 57/03; A01D 57/04

(57) ABSTRACT

The present invention relates to a harvesting appliance (2), having a reel (12), which has a number of tine carriers (22), non-rotatably mounted on which, in a distributed manner over the length thereof, there are a number of reel tines (28), the tine carriers (22) being rotatably connected to the spoke elements (26). In order to protect the reel tines against an overload, each tine carrier (22) is held in a rotational position via a support element (30) against a variable-length energy store (32), which permits a yielding motion of the reel tines (28) when a load is applied to the reel tines (28).

### CROSS REFERENCE TO RELATED APPLICATIONS

This application claims priority under 35 U.S.C. § 119 to German Patent Application DE 10 2024 114 532.3, filed May 23, 2024, which is herein incorporated by reference in its entirety, including without limitation, the specification, claims, and abstract, as well as any figures, tables, appendices, or drawings thereof.

### FIELD OF THE INVENTION

The present invention relates to a harvesting appliance having a reel protected against overload.

### BACKGROUND OF THE INVENTION

The background description provided herein gives context for the present disclosure. Work of the presently named inventors and aspects of the description that may not otherwise qualify as prior art at the time of filing are neither expressly nor impliedly admitted as prior art.

A harvesting appliance of the generic type that has a reel is known from EP 1 297 735 A1. This harvesting appliance is a cereal cutting header, but the invention also relates to other harvesting appliances that are provided with a reel. The cutting device is composed of a cutter bar having knives driven in reciprocating motion. As conveying devices, the already known cereal cutting header has a continuously revolving conveyor belt, which delivers the cut crop in a direction transverse to the working direction of a transfer interface in the form of a transfer opening to the inclined conveyor of a combine harvester, and has a reel, which discharges the cut crop onto the conveyor table of the cutting header after it has been cut by the cutter bar. In the case of other harvesting appliances, to which the invention also relates, other conveying devices are used as an alternative or in addition to a reel, such as, for example, cross conveyor screws, chain conveyors, rotors, and the like.

In the case of the already known harvesting appliance, the central carrying body of the reel is realized as a tube. Reel spiders, which in this case form the spoke elements, are bolted, clamped, or welded to the central carrying body.

The reel tines are mounted in a non-rotatable manner on tine carriers, and the tine carriers are rotatably connected to the spoke elements. The tine carriers are each firmly connected, at at least one of their ends, to a drive rod, of which the end that faces away from the tine carrier is held in a curved path. As the reel rotates, the ends of the drive rods held in the curved path follow the course of the curved path. The changing distances of the curved path from the envelope circle of the reel in the course of one revolution of the reel give rise to different angular positions of the drive rods, revolving with the reel, relative to the envelope circle of the reel, and the different angular positions result in rotary motions of the tine carriers, causing the outer tips of the reel tines to swivel outward or inward. This results in a positively controlled non-circular motion path of the outer tips of the reel tines.

The purpose of the positively controlled motion of the tips of the reel tines is to allow the tine tips to reach as far forward as possible in the working direction of the harvester carrying the harvesting appliance when they first come into contact with the crop, in order to grasp the crop as early as possible with these tips and, as the rotary motion progresses, to throw it toward the conveyor devices upon the respective tine carrier being lowered further toward the ground and moving backward.

In general, positively controlled reel tines fastened to tine carriers that are rotatably mounted on the spoke elements carrying them do function well. However, problems may arise if the reel tines touch the ground during their rotational motion and/or if the amount of material to be harvested—for example, in the case of cereal for storage—is so great or so heavy to pick up that it bends the tips of the reel tines, or even forces the reel tines upward into the tine carriers.

In particular, the ever increasing working widths of harvesting appliances may result in forces that permanently deform the tine carriers, or even the spoke elements, necessitating their repair. As a result of being positively guided, the reel tines cannot reduce the load peaks by means of a yielding motion. In practice, one remedy is to use flexible materials from which the reel tines may be produced. However, reel tines produced from softer materials no longer have optimum grip. The restoring forces that build up in the flexible reel tines during a yielding motion act both upon the tine carriers and upon the spoke elements, which, therefore, have to be of greater strength, and, consequently of greater weight. The ever-increasing working widths of the harvesting appliances result in considerable additional weight, which ultimately also leads to more robustly dimensioned drives, more robustly dimensioned carrying devices on the harvesting machine and, due to the greater machine weight, greater soil compaction in the cultivated area.

Thus, there exists a need in the art for a harvesting device to have a reel protected against overload.

### SUMMARY OF THE INVENTION

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

This present disclosure includes a harvesting appliance having a frame, at least one cutting device connected to the frame, a number of conveyor devices and a transfer interface, one of the conveyor devices is realized as a reel, which is connected to the frame via height-adjustable retaining arms and which can be driven in rotation about its longitudinal axis via a drive device, the reel has a central carrying body that extends in a direction along the longitudinal axis of the reel, the reel additionally has a number of tine carriers, the longitudinal axes of which extend in a direction along the longitudinal axis of the reel and parallel to the central carrying body and which are arranged in a distributed manner on a circle around the longitudinal axis of the reel, the central carrying body is connected to the tine carriers via spoke elements arranged at a distance from one another over the longitudinal axis of the reel, mounted in a non-rotatable manner on each of the tine carriers, distributed over the length thereof, are a number of reel tines, and the tine carriers are rotatably connected to the spoke elements, wherein each tine carrier is held in a rotational position via a support element assigned to the tine carrier, the support elements are supported on an eccentric drive, which moves the support elements during a full revolution of the reel in the radial direction into different positions relative to the carrying body, and interposed between the eccentric drive and a connection of a respective support element to an associated tine carrier there is variable-length energy store, which permits a yielding motion of the reel tines when a load is applied to the reel tines.

It is the object of the present invention to propose a harvesting appliance having a reel that is able to absorb the greater forces resulting from the tips of the reel tines coming into contact with the ground or from a greater amount of crop acting upon the reel tines, without this requiring a significant increase in the weight of the components of the reel that could potentially be damaged by overloading.

The tine carriers are each rotatably connected to the spoke elements via a pivot bearing. Here, rotatably means that, in a first exemplary design, the tine carriers may be rotatably mounted in pivot bearings that are connected to the spoke elements in a fixed position. The tine carriers are thus only rotatable about their longitudinal axis. In a second alternative and exemplary design, however, the tine carriers may also be rotatably connected to the spoke elements in that the tine carriers are held non-rotatably on tabs, which in turn are pivotably connected to the spoke elements via a fixed revolute joint. The tine carriers are then rotatably connected to the spoke elements via a swivel motion of the tabs. In a third exemplary design of the rotational mobility, the tine carriers may also be rotatably mounted in a pivot bearing in the tabs, which in turn are again connected to the spoke elements via an articulated joint. Within the meaning of the invention, therefore, the rotational mobility is to be understood in a broad sense.

Each tine carrier is connected, via connection means, to a support element assigned to this tine carrier, and is thus held in a rotational position. Since the tine carriers are rotatably connected to the spoke elements, they can theoretically assume different rotational positions. However, in order to fulfill their function of supporting the crop during cutting and transferring it to the downstream conveyor elements, the reel tines, and in particular the tips of the reel tines, have to be in a defined position as the reel rotates. The rotational position in which the tine carriers are held is, therefore, not inconsequential. In order to hold the tine carriers in a wanted rotational position, each tine carrier is connected to an assigned support element, in which a technically advantageous rotational position of the respective tine carrier, and thus also of the reel tines fastened thereto in a non-rotatable manner, is established via the connecting means by which the support element is connected to the tine carrier.

Various components may be used as support elements. They may be a rigid or movable linkage, rigid or movable retaining tabs, a metal-plate structure, or a comparable component. The support element may be connected to the central carrying body and supported on it, such that it rotates together with the reel. The forces acting upon the reel tines are then transmitted to the central carrying body.

The support elements are supported on an eccentric drive, which moves the support elements in a radial direction into different positions relative to the carrying body during a full rotation of the reel. The eccentric drive may be realized, for example, as a curved path that is arranged eccentrically in relation to the axis of rotation of the reel and/or that has a non-circular shape. The axis of rotation of the reel corresponds to its longitudinal axis.

Interposed between the eccentric drive and a connection between a respective support element and an associated tine carrier there is a variable-length energy store, which permits a yielding motion of the reel tines when a load is applied to the reel tines. The statement that there is a variable-length energy store interposed between the eccentric drive and the connection between the support element and the associated tine carrier is understood to mean that a variable-length energy store may be arranged in the eccentric drive itself and on any further component that transmits the actuating force, generated by the eccentric drive, to the tine carrier.

For example, coil or leaf springs, rubber buffers, gas pressure springs, and the like may be used as energy stores. Upon deformation, in particular a change in length, the energy store absorbs forces that act as restoring forces when the load acting upon it is removed again. Depending on the structural design, the restoring forces build-up due to compression or elongation of the energy store. They are reduced again as the energy store returns to its original shape and, in particular, its original length. If an overload that has changed the length of the energy store is removed, the energy store returns to its original position due to the restoring forces, and the tine carrier, with the reel tines fastened to it, is also back in the rotational position in which it was before the overload began to act upon the reel tines. In this way, the energy store is self-regulating. It does not require any switching or active open-loop or closed-loop control. It automatically sets itself to a length that matches the acting overload in such a way that this length results in a technically advantageous rotational position of the tine carrier, and, consequently, of the reel tines, for the respective acting load. Since the rotary motion of the reel moves the reel tines in the region of their lowest point during one revolution of the reel toward the ground and the crop, a yielding motion of the reel tines in a direction opposite to the direction of rotation of the reel is suitable for reducing load peaks that occur and protecting the reel tines from a possible overload.

The deformation behavior of the energy store, in particular its length change behavior, may be set via its shape, the material used, the material thicknesses and the like, such that it does not deform, or deforms only insignificantly, as long as the forces acting upon the reel tines remain below a level at which there is no risk of permanent damage to the reel tines or the tine carrier. The forces below this level acting upon the reel tines are normal loads that occur during regular operation of the harvesting appliance. When the harvesting appliance is in normal operating mode, the tips of the reel tines, therefore, maintain a position and alignment that allow good support of the crop during cutting, and good transfer of the cut crop from the field to the conveyor devices. However, if the acting loads exceed this level and reach an overload level, the energy store changes its shape, in particular its length, and thereby enables the reel tines, by a rotary motion of the tine carrier about its axis of rotation, to at least partially yield away from the acting overload, into a different rotational position, thereby reducing it. In this way, the variable-length energy store serves as an overload protection.

The overload absorbed by the energy store is transmitted to the central carrying body. This significantly reduces the risk that a tine carrier could be permanently deformed and damaged by an overload acting upon the reel tines. Repair-related downtimes of the harvesting appliance and the corresponding repair costs are reduced significantly. The tine carriers and the spoke elements may be designed for lower load assumptions, which reduces their weight and, thus, the overall weight of the reel.

If each tine carrier of a reel can transmit acting overloads to the central carrying body via an energy store, it is possible that only the tine carrier on which the overload is actually acting yields with a rotary motion into a new rotational position. The reel tines of those tine carriers that are not subjected to an overload remain in their rotational position corresponding to the normal position, such that the tine carriers not subjected to overload maintain their normal conveying action, with continuous rotation. Additionally, each tine carrier of which the reel tines are subjected to overload is individually adjusted in its rotational position only insofar as is necessary to reduce the overload acting upon it. This also means that, even if there is an acting overload, the normal conveying function of the reel is impaired only to the extent that is necessary, due to the reel tines being rotated away as a result of the alteration of the rotational position of the tine carriers.

The reel works as a kind of rotating rake, with an exactly or at least substantially cylindrical basic shape, the longitudinal axis of which extends in a direction transverse to the working direction of the harvesting appliance. During cutting, the reel supports the crop to be cut in the upper region, or—in the case of cereal for storage, for example—picks it up from the ground and, after cutting, discharges it into the functional of the conveying devices located behind the cutting device in the direction of conveyance of the crop.

The central carrying body may be formed from a single tubular piece, or a plurality of tubular pieces may be joined together to form a central tubular body, in particular, joined together in succession in the direction of extent. The central tubular body may be composed of a closed tube or be of an open design, for example, having openings in the tube wall, or having a plurality of tubes, for example, arranged in a circle, which together form the central tubular body across the working width of the harvesting appliance, or in individual sub-sections.

The spoke elements may be in the form of a metal-plate spider, but there may also be individual struts for each spoke, or a spoke element may be made up of a plurality of components.

According to one design of the invention, the eccentric drive has a slideway in which the support elements are guided at a respective end, a wall section of the slideway is mounted in a movable manner, and the movably mounted wall section of the slideway is supported against a variable-length energy store. A conventional slideway guides a respective end of a support element with precision along the course of the slideway without large tolerances. Since the spatial position of the support elements in relation to the axis of rotation of the reel determines the swivel position of the reel tines controlled by the respective support element via corresponding coupling elements, and the slideway is designed to set the reel tines to a swivel position corresponding precisely to the rotational position of the reel in the course of one revolution of the reel, tolerances in the guidance of the support element in normal operating mode are undesirable in the slideway. Fixed lateral walls of the slideway force the respective end of a support element, and thus also the associated tine carrier, due to the respective spatial position of the associated support element, to maintain the swivel position predefined by the curved path even under the action of a greater load upon the reel tines.

As a result of a wall section of the curved path being mounted in a movable manner, it is now possible for the respective end of a support element guided in the slideway in the region of this wall section to yield from the predefined curved path by the amount by which the movably mounted wall section swivels in. However, as a result of the movably mounted section being supported against a variable-length energy store, the movably mounted wall section swivels out of its normal position only if there acts upon the wall section a force that is greater than the resistance force by which the variable-length energy store opposes a shortening of the length. If the variable-length energy store is designed in such a way that it allows a swiveling-in motion of the movable wall section only when forces acting upon the reel tines are close to an overload, the wall section supported by the variable-length energy store acts as an overload protection, which transmits forces acting upon the reel tines through a yielding motion to the variable-length energy store, and which the latter diverts to the central carrying body. Since the free ends of the reel tines are swiveled backward, counter to the direction of rotation of the reel, during a swivel motion, the forces to which the reel tines are subjected are reduced because the distance between the free ends of the reel tines and the ground and the crop increases. The variable-length energy store advantageously builds up restoring forces that move the movable section back to its original position after the overload has ceased, with the support elements, and the tine carriers moved by them, also being moved back to their normal position.

According to one design of the invention, the movably mounted section has a pivot bearing at its rear end, as viewed in the direction of rotation of the reel, and is supported at its front end by the variable-length energy store. Since the movably mounted wall section rotates about the pivot bearing located at the rear end, and the front end dips against the force of the variable-length energy store, jerky deflection motions of the support elements are avoided. Due to the lever principle, the further away the contact point of the support element, with the movably mounted section, is from the pivot bearing, the deeper the movably mounted wall section dips against the variable-length energy store under the action of a force. In the proposed design, this is the case at the front end of the movably mounted section. If the reel tines fastened to a tine carrier are lowered further downward when the end of the support element controlled by the curved path is located in this part of the movable wall section, this results in a very soft spring behavior of the movably mounted wall section. However, the further the end of a support element, controlled by the curved path, moves along the movably mounted wall section during a revolution, the smaller the lever forces that assist a deflection motion become, and the less easily the movably mounted wall section actually deflects inwardly. However, because the reel tines connected to the support element are approaching their lowest position, the rotational motion of the reel may also increase the counterforces acting upon the reel tines. This opposing force characteristic allows the reel tines to maintain approximately their nominal position, and it is only in the event of considerable overloads, which in particular may also occur as a peak force, that the movably mounted section would deflect further inward, thereby enabling a yielding motion of the reel tines. The yielding motions of the movably mounted wall section are fluid, resulting in more uniform swivel motions of the reel tines. If, under the action of an overload, an end of a support element guided in the slideway reaches the end of the movably mounted wall section located in the direction of rotation, this is where the movably mounted wall section is least flexible, as this is where the swivel axis is located.

The curved path should, therefore, be configured in such a way that an end of a support element guided in the curved path reaches the rear end of the movably mounted wall section, and thus the position of the swivel axis, only when the tips of the reel tines have already passed the bottom dead center during a revolution.

According to one design of the invention, the movably mounted wall section is located in a section of the slideway in which the slideway guides the support elements, the tine carriers of which, during a rotational motion of the reel, move in the region of what is the lowest position during a revolution. The greatest forces acting upon the reel tines are when the reel tines move close to the ground and in the region where the crop gathered by the reel tines is delivered to the harvesting appliances, with the reel tines being located in the region of their lowest position during a rotation. For this reason, it is advantageous for the movably mounted wall section to be arranged in the section of the slideway in which the slideway guides the support elements of which the tine carriers, during a rotational motion of the reel, move in the region of what is the lowest position during a revolution.

According to one design of the invention, the movably mounted wall section deflects inward, against the force of the variable-length energy store, in a radial direction toward the longitudinal axis of the reel. When the movably mounted wall section deflects in the direction of the longitudinal axis of the reel, the movably mounted wall section moves away from the crop, which is located on the outer circumference of the reel. This reduces the risk that crop material could accumulate on the movably mounted wall section and become wound up on the reel. With this arrangement, the variable-length energy store is also located in a region away from the crop, such that, there too, the risk of crop being carried along and becoming wound up is also reduced. The deflection motion of the movably mounted wall section deeper into the interior of the reel is also advantageous because that is where there is sufficient installation space available and the circumference of the slideway does not increase toward the outside.

According to one design of the invention, the support elements are arranged so as to lag behind the tine carriers in the direction of rotation. With a lagging arrangement of the support elements, they are moved in the direction of the longitudinal axis of the reel when there is a deflection motion triggered by an overload. In the shadow of the reel tines, there is less risk of crop being picked up by the support elements and becoming wound up on the reel.

According to one design of the invention, interposed between the tine carrier and the support element, there is a variable-length energy store, which permits a yielding motion of the reel tines when a load is applied to the reel tines. This solution is a design of the invention that is an alternative to the exemplary embodiment described above. In this exemplary embodiment, the variable-length energy store is not arranged in the region of the eccentric drive, but in the region between the tine carrier and the support element.

According to one design of the invention, the support elements and energy store are arranged at at least one end face of the reel. Since the support elements and the energy store are easily accessible at the end faces of the reel, they can be easily mounted and serviced there. Because the reel is held at its end faces by the support arms, the additional weight resulting from the support elements and the energy stores is also located in the immediate vicinity of the support arms, such that the central tubular body does not have to bear any additional lever forces from the weight of the support elements. In order for an overload, acting upon the reel tines of a tine carrier, to be diverted to the central tubular body via an energy store and a support element, it may be sufficient for these machine elements to be arranged at only one end face of the reel.

According to one design of the invention, the tine carriers are rotatably connected to the spoke elements in that the tine carriers are held non-rotatably on tabs, which in turn are pivotably connected to the spoke elements via a revolute joint, and an energy store assigned to a tine carrier is rotatably connected at least to a tab of the assigned tine carrier, and optionally also to the support element assigned to it, via revolute joints. Depending on the length and width dimensions of the tabs, the position of the tine carrier on a tab, the placement of the revolute joints on the tab and the energy store, and the length of the adjustment range by which the length of the energy store can be varied, adjustment ranges are obtained by which the position of a tine carrier, and thus also of the tips of the reel tines, which are fixedly fastened to the tine carrier, are maximally variable relative to the rest of the reel under the action of an overload. The corresponding dimensions and positions of the components may be selected in such a way that a maximum adjustment range sufficient for the respective application is established for the tips of the reel tines under the action of an overload.

For an individual tine carrier, the various rotatable connections that connect the components to one another create an at least three-jointed connection between the tabs connected to the tine carrier, the spoke elements, and the energy store. The first joint, in this case, may be formed by the rotatable connection of a tab to the spoke elements. The second joint may be formed by the rotatable connection of at least one tab, assigned to the tine carrier, to the assigned energy store. The third joint may be formed by the rotatable connection of the energy store to the intermediate element. This at least three-jointed connection of the components to one another defines an adjustment range within which the tine carrier can move under the action of an overload.

According to one design of the invention, the energy store assigned to a tine carrier is coupled, at its end that faces toward the tine carrier, to a guide element, the movability of which is positively guided by means of a guide link, and the tine carrier is indirectly connected to the energy store, directly or indirectly only via a revolute joint, by means of the guide element. As a result of the tine carrier being connected to the energy store assigned to this tine carrier via the guide element, which mediates the connection and is positively guided in a guide link, it is ensured that the motion component resulting from the change in length of the energy store, and which also determines the adjustment range of the tine carrier in the case of an acting overload, is taken from a defined motion path from which the energy store cannot deviate. The positively driven guide element thus determines both the adjustment range assumed by the energy store under the action of an overload and the length and direction of the motion component that affects the adjustment range of the tine carrier under the action of an overload. An example of a guide link for a positive guide is a guide rod on which a sliding sleeve is guided as a guide element, and to which the energy store and the tine carrier are directly or indirectly connected. If the length of the energy store changes, the position of the sliding sleeve on the guide rod changes accordingly, and if the position of the sliding sleeve on the guide rod changes, it takes the tine carrier connected thereto with it in accordance with the geometric ratios of the connection.

According to one design of the invention, the guide link is in the form of an eccentric drive. An eccentric drive can be realized in a technically simple and inexpensive manner, its functioning is purely mechanical, and it is virtually maintenance-free. It requires only a small amount of installation space at the end face of the reel, and provides reliably functioning motion control of the reel tines over the service life of the harvesting header.

According to one design of the invention, the guide link is connected to a drive rod driven so as to move in a radial direction relative to the axis of rotation of the reel, and the end of the energy store that faces away from the tine carrier is fastened at a fixed position. The guide link may be in the form of an eccentric drive, for example. In order to transmit the motions of an eccentric ring belonging to the eccentric drive to the reel tines, the guide link may be connected to a drive rod that is driven so as to move in a radial direction relative to the axis of rotation of the reel, and the end of the energy store that faces away from the tine carrier is fastened at a fixed position. The driven drive rod makes it possible to introduce into the motion of the tine carrier a further component of motion by means of which the reel tines are no longer fixed in the normal position in relation to the reel, in which no overload acts upon them, but follow a motion curve induced by the drive rod in the course of a revolution of the reel. Since the end of the energy store that faces away from the tine carrier is fastened at a fixed position, only the end of the energy store that faces outward remains movable along the adjustment range in order to absorb an acting overload. In particular, the fixed position at which the end of the energy store that faces away from the tine carrier is located may also be arranged on the drive rod.

If the drive rod is then moved in a certain direction, the energy store and the guide element connected to the drive rod as a guide link follow the motions of the drive rod. Since the tine carrier is connected to the guide element, the component of motion transmitted from the motion of the drive rod to the guide element is also transmitted to the tine carrier. Since the motions transmitted from the guide element to the tine carrier alter the rotational position of the tine carrier in its mounting, this inevitably also results in a change in the position of the tips of the reel tines relative to the rest of the reel. With the driven motions of the drive rod, the tips of the reel tines can be controlled in a non-circular envelope curve in the course of a revolution of the reel, due to the forced guidance via the drive rod.

Thus, if the drive rod with the guide element is moved inward or outward along its direction of extent in an at least approximately radial direction, this component of motion is converted, via the connection of the guide element to the tine carrier, into a rotation of the tine carrier, which results in correspondingly different rotational positions of the tine carrier relative to the rest of the reel during one rotation of the reel. With these rotary motions of the tine carrier, the tips of the reel tines connected to it are also positively adjusted in a wanted direction.

When reference is made at this point to a motion of the drive rod in a radial direction, this motion does not have to be directed in an exactly radial direction starting from the axis of rotation of the reel. A motion in a radial direction means a motion that includes at least one component of motion that causes the outward-facing end of the drive rod to move away from or toward the axis of rotation of the reel. The drive rod also does not necessarily have to be oriented so that its longitudinal direction faces exactly toward the axis of rotation of the reel. Rather, it may also be arranged so that its longitudinal center axis does not intersect the axis of rotation of the reel.

Driving of the drive rod may be effected, for example, via a slideway in which the end of the drive rod that faces toward the tine carrier is guided. The slideway may be arranged with an eccentric offset relative to the axis of rotation of the reel center tube, or it may have a non-circular path.

According to one design of the invention, the energy store assigned to a tine carrier is in the form of a leaf spring. Depending on the material and design, leaf springs can withstand high mechanical loads, are easy to mount and repair, and can be designed precisely to a wanted spring characteristic. Leaf springs may be produced from a metallic material such as, for example, spring steel, but plastic versions are also possible, in which case the plastic is then advantageously fiber-reinforced, for example, as a GfRP or CfRP fiber composite component.

According to one design of the invention, the harvesting appliance has a plurality of frame sections arranged next to one another and articulated to one another, and a plurality of reels arranged next to one another and articulated to one another, the reels being designed according to the features of the preceding designs. For the invention, it is irrelevant whether the harvesting appliance is provided over its working width with a single rigid frame that extends over the entire working width of the harvesting appliance, or whether it is divided into a plurality of frame sections that are articulated to one another and that each cover only partial working widths. In the latter case, the reel may also be of a multipart design, in which case each reel segment, or some of the reel segments, may be designed according to the invention. The number and width of the reels used in a multipart harvesting appliance does not have to correspond to the number and width of the frame sections.

According to one design of the invention, included for the function of the support element, there is a non-compression-rigid retaining means, which is connected to the variable-length energy store at at least one first point, and is held in a fixed position at at least one second point and, in its normal position, holds the variable-length energy store under a preload. This structural design is lightweight, cost-effective and space-saving. For the inward and outward deflection motions of the energy store, motions of guide elements along link guides that are susceptible to wear and sensitive to fouling are avoided, because the non-compression-rigid retaining means relaxes as soon as the energy store deflects inward, and does not require any motion control to enable it to return to its normal position when the energy store subsequently springs back.

According to one design of the invention, the guide link is in the form of an eccentric drive, and a rotary motion between the eccentric drive and a spoke element is synchronized by means of a link that connects the spoke element and the eccentric drive to one another in an articulated manner, the longitudinal axis of the link extending at least partially in the direction of rotation of the reel. If a non-compression-rigid retaining means is included for the function of the support element, an elasticity is introduced into the control of the curved path of the reel tines, which would no longer control the swivel motions of the reel tines with the wanted precision. The link can be used to limit or completely prevent rotational angle adjustments of the eccentric drive, in particular if this is effected by means of an eccentric ring, relative to the carrying body. If the link is positioned in such a way that the longitudinal axis of the link extends at least partially in the direction of rotation of the reel, this results in good power transmission between the eccentric drive and the spoke element.

According to one design of the invention, the link can be fixed in various positions via fastening means. Depending on the relative position in which the link is fixed on the reel, different swivel positions of the reel tines are obtained. Thus, for example, it may be advantageous to swivel the reel tines from the working position to a transport position in order to avoid any damage during transport. For example, a plurality of drilled holes positioned at a distance from one another may be provided in the link as fastening means, which can be used selectively for screw connection to the reel. Instead of a screw connection via various drilled holes, other fastening means are also possible, such as, for example, latching lugs realized on the link, which can be inserted into corresponding receiving holes, or other known solutions for fastening a component in different positions.

According to one design of the invention, the bending moments required to alter the shape of at least two reel tines in the direction of rotation are greater than the moment of force required to alter the shape of the variable-length energy store. Since the reel tines are protected against overload by the variable-length energy store, they may be realized so as to be less flexible in the direction of rotation. In order to avoid breaking off the reel tines, hitherto they have often been produced from a relatively soft plastic that allows the shape to be altered if an excessively high bending moment acts upon the respective reel tines. The disadvantage of this solution is that the reel tines do not rake up the crop with sufficient vigor in difficult harvesting conditions. The new type of overload protection now allows the reel tines to be made stiffer again, such that they at least retain their original shape, and thus also their conveying vigor, for substantially longer when subjected to a greater bending moment. They may still be produced from a plastic material, but one that deforms less easily. They may also be made of a metallic material.

According to one design of the invention, there are no separate means for overload protection between the reel tines and the tine carriers. The overload protection for the reel tines by means of the variable-length energy store makes it possible to dispense with hitherto customary used overload protection devices between the reel tines and the tine carriers, such as, for example, spiral springs. As a result, the amount of assembly work and the weight of the reel are reduced.

Further features of the invention result from the claims, the figures, and the description of the figures. All the features and combinations of features which are mentioned above in the description, and the features and combinations of features which are mentioned in the following text in the description of the figures and/or are shown only in the figures and can be used not only in the respective specified combination, but rather also in other combinations or else on their own. These and/or other objects, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Further modifications and embodiments of the invention can be derived from the following description of the subject matter and the drawings. The invention is now to be explained in more detail with reference to exemplary embodiments. Moreover, further advantages and details are shown in the claims and in the embodiment examples shown in the drawings:

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

In the drawings:

FIG. 1 shows an oblique front view of a harvesting appliance having a first exemplary embodiment of the invention;

FIG. 2 shows an oblique front view of a reel;

FIG. 3 shows the reel shown in FIG. 2 in an enlarged view of the end face, with all spring tines in the normal position:

FIG. 4 shows the view of the reel shown in FIG. 3, but with one reel tine shown in an inwardly deflected position; and

FIG. 5 shows a schematic side view of a second exemplary embodiment.

The illustrations are substantially actual exemplary embodiments. However, the invention is not limited to the exemplary embodiments represented, but may be modified according to the skilled art in order to adapt it to a particular application.

Where appropriate, mutually corresponding components are denoted by identical reference numerals in all figures. For reasons of clarity, however, not all components that occur multiple times are denoted by reference numerals in each case.

Presented below are a plurality of exemplary embodiments of how the support elements 30 may be supported on an eccentric drive 44, which moves the support elements 30 during a full revolution of the reel 12 in the radial direction into different positions relative to the carrying body 20, and interposed between the eccentric drive 44 and a connection of a respective support element 30 to an associated tine carrier 22a there is variable-length energy store 32, which permits a yielding motion of the reel tines 28 when a load L is applied to the reel tines 28.

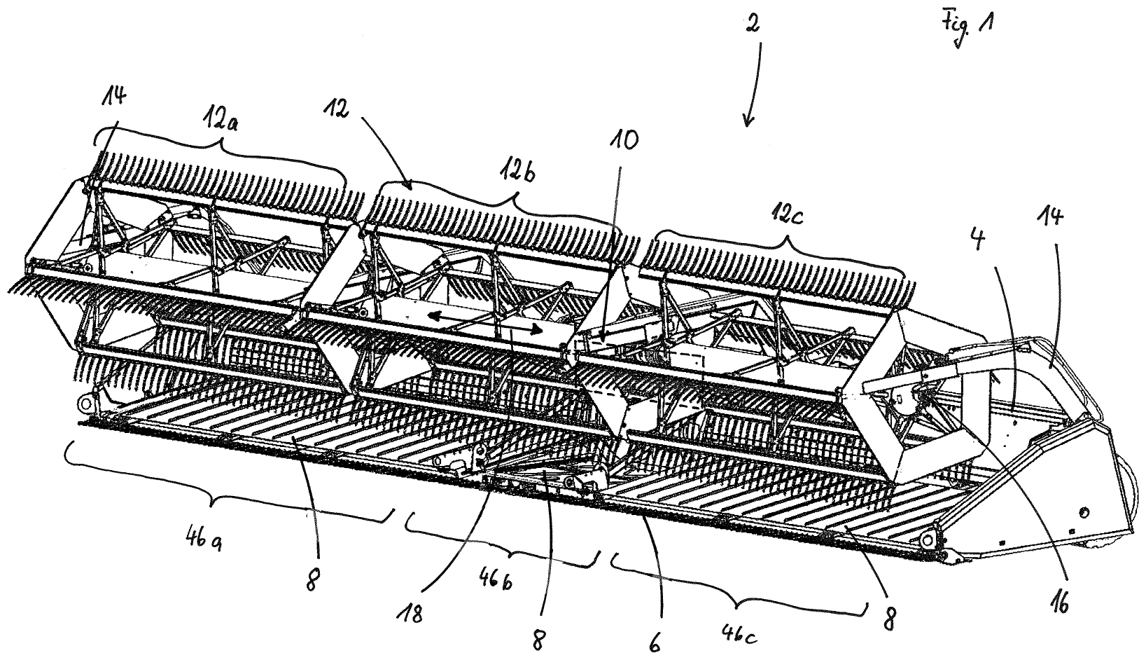

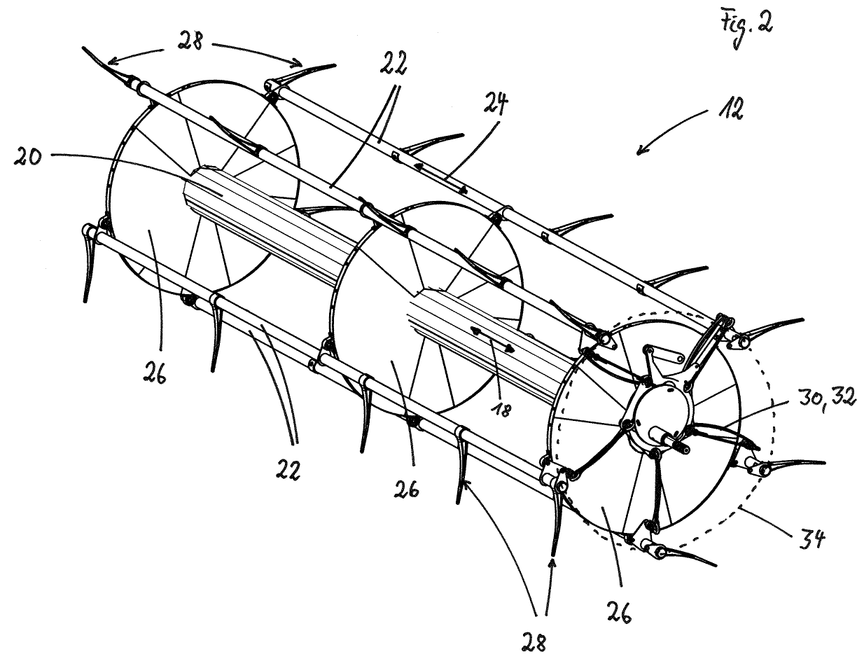

Shown in FIG. 1 is a harvesting appliance 2 having a frame 4, a cutting device 6, a conveyor device 8, which in the exemplary embodiment is realized as a belt conveyor, and a transfer interface 10 arranged at the rear and represented schematically only by dashed lines. In the front region of the harvesting appliance 2, located above the cutting device 6, there is a reel 12 that, as one of the conveying devices in the harvesting appliance, is held at its end faces on a respective height-adjustable retaining arm 14 connected to the frame 4. During harvesting work, a drive device 16 causes the reel 12 to be set in a rotating motion, during which it rotates about its longitudinal axis 18. There are a number of tine carriers 22 that are arranged in a distributed manner around the longitudinal axis 18 of the reel 12, on a circle 34 that in FIG. 2 is represented by a dashed line.

In the exemplary embodiment shown in FIG. 1, the harvesting appliance 2 has a frame section 46, such as a plurality of mutually articulated frame sections 46a, 46b, 46c arranged next to one another, and a plurality of mutually articulated reels 12a, 12b, 12c arranged next to one another, which are designed according to the teachings of the present invention.

FIG. 2 shows a reel 12 having the first exemplary embodiment, in a simplified, more detailed view. This view shows the carrying body 20, which is designed as a single tube and to which the tine carriers 22 are connected. In the exemplary embodiment, the longitudinal axis 24 of the tine carriers extends in a direction parallel to the longitudinal axis 18 of the reel 12. The carrying body 20 and the tine carriers 22 are connected to each other via spoke elements 26. There are a number of reel tines 28 arranged along the length of each of the tine carriers 22. The reel tines 28 are mounted in a non-rotatable manner on the tine carriers 22, and the tine carriers 22 are rotatably connected to the spoke elements 26. Arranged at the end face of the reel 12 are the components by means of which the angular position of the reel tines 28 is controlled during a revolution of the reel 12. The components include the support elements 30 and energy stores 32.

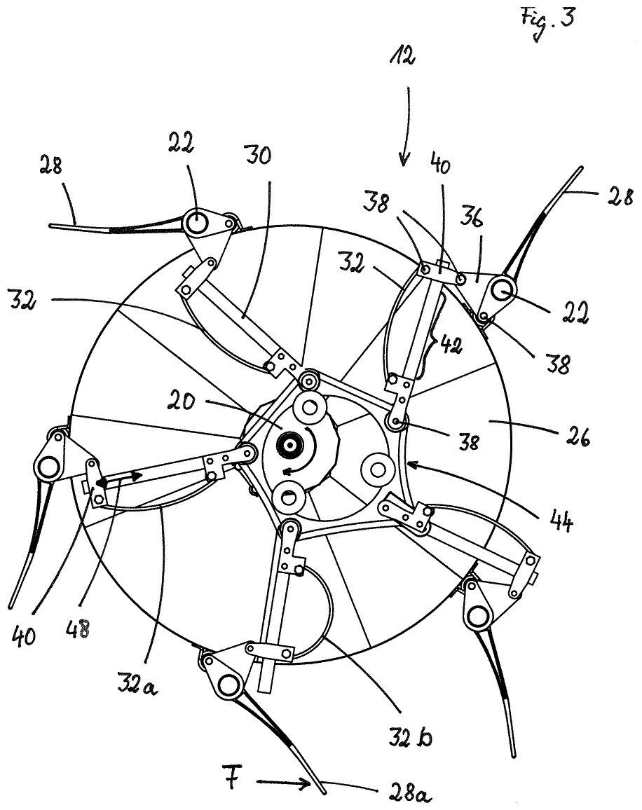

The direction of rotation of the reel 12 is indicated in FIG. 3 by a corresponding arrow around the central shaft. As shown in FIG. 3, each tine carrier 22 is held in a rotational position via a support element 30 assigned to the tine carrier 22. Interposed between the tine carrier 22 and the support element 30, there is a variable-length energy store 32, which permits a yielding motion of the reel tines 28 when a load is applied to the reel tines 28. In the first exemplary embodiment represented in FIG. 3, the energy store 32 assigned to a tine carrier 22 is in the form of a leaf spring. Other designs of an energy store 32 are, of course, possible. While the energy store 32a in FIG. 3 is shown in a relaxed state, in which the associated reel tine is also in a normal position, it can be seen from the more bent shape of the energy store 32b that the latter has changed its shape due to the force F acting upon the reel tines 28a. At the same time, the force F has pushed the reel tine 28a from its normal position into the position shown in FIG. 3, in which it is in a rotational position in which the tip of the reel tine 28a is displaced anti-clockwise from the normal position in the direction of the force F acting upon it. As soon as the force F ceases, the energy store 32b moves back to its normal position, and, in so doing, also moves the reel tine 28a back to its normal position.

The tine carriers 22 represented in FIG. 3 are rotatably connected to the spoke elements 26 in that the tine carriers 22 are held in a non-rotatable manner on tabs 36, which in turn are each pivotably connected to the spoke elements 26 via a revolute joint 38, and an energy store 32 assigned to a tine carrier 22 is rotatably connected at least to a tab 36 of the assigned tine carrier 22 and optionally also to the support element 30 assigned to it via revolute joints 38. The energy store 32, respectively assigned to a tine carrier 22, is coupled, at its end that faces toward the tine carrier 22, to a guide element 40, the movability of which is positively guided along the adjustment range 48 by means of a guide link 42. In the exemplary embodiment shown, the tine carrier 22 is indirectly connected to the guide element 40 only via the tab 36 and a revolute joint 38, and only via the latter to the energy store 32. In deviation from the exemplary embodiment shown, it is also possible for the tine carrier 22 to be directly connected to the guide element 40 and/or to the energy store 32 via a revolute joint 38.

In the first exemplary embodiment shown in FIG. 3, the guide link 42 is realized as a drive rod driven so as to move in a radial direction relative to the axis of rotation of the reel 12, and to which the end of the energy store 32 that faces away from the tine carrier 22 is fastened at a fixed position. The fixed position is realized as a revolute joint 38, via which the guide link 42 is connected to the eccentric drive 44.

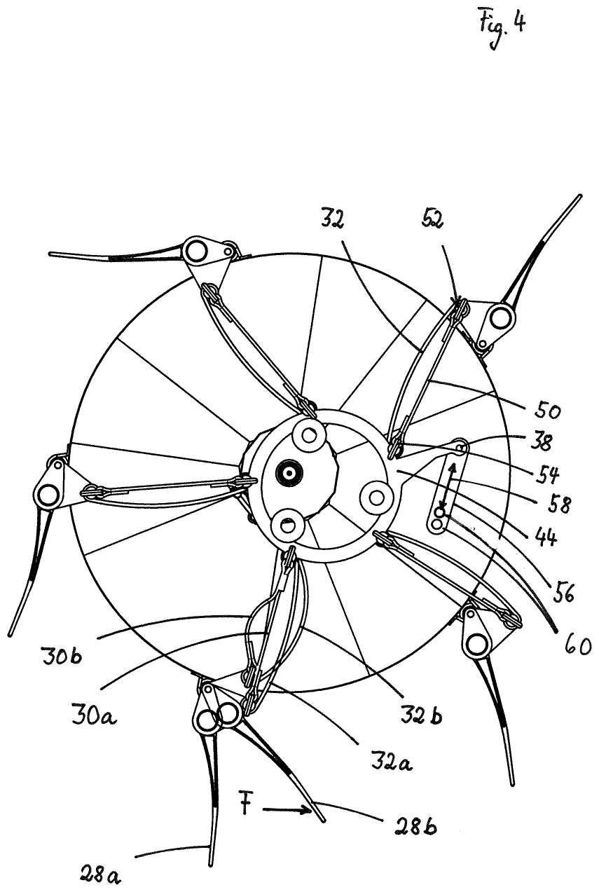

FIG. 4 shows an exemplary embodiment of the invention in which the function of the support element 30 is provided by a non-compression-rigid retaining means 50. In the exemplary embodiment, the non-compression-rigid retaining means 50 is, for example, a cable, which is connected to the variable-length energy store 32 at at least one first point 52, and is held fixed at at least one second point 54. When the non-compression-rigid retaining means 50 holds the variable-length energy store 32 in its normal position under a preload, it is held taut against the second point 54. In this way, in normal operating mode, the non-compression-rigid retaining means 50, and the variable energy store 32 forms a functional unit without the action of an overload, this being suitable for transmitting control pulses of a curved path control for the reel tines 28. In the exemplary embodiment, the non-compression-rigid retaining means 50 is connected to the eccentric drive 44. The eccentric rotary motion of the latter is transmitted via the non-compression-rigid retaining means 50, which is held taught, to the associated tine carrier 22, as a result of action in combination with the energy store 32 as a functional unit, such that the reel tines 28 fastened to it move along a controlled motion path in the course of a revolution of the reel 12.

FIG. 4 also shows how the functional unit comprising the non-rigid retaining means 50, and the energy store 32 behaves under the action of an overload. While the reel tine 28a, the non-compression-rigid retaining means 50a, and the energy store 32a, without the action of an overload, are in the respective positions indicated in FIG. 4, the spatial position of these components relative to the rest of the reel 12 changes to the positions indicated in FIG. 4 for the reel tine 28b, the non-compression-rigid retaining means 50b and the energy store 32b. Since the overload shortens the component length of the energy store 32 along the adjustment range, the non-compression-rigid retaining means 50 is no longer held taut under the action of an overload upon the associated reel tines 28, and now only hangs in a slack state between the points 52, 54. The energy store 32, however, is preloaded by the acting overload and loaded with a restoring force. As soon as the overload ceases, the reel tines 28, the non-compression-rigid retaining means 50, and the energy store 32 moves back to its normal position.

In order to synchronize a rotary motion between the eccentric drive 44 and the spoke element 26, a link 56 is used, which articulates the spoke element 26 and the eccentric drive 44 to each other via a revolute joint 38. The longitudinal axis 58 of the link 56 extends at least partially in the direction of rotation of the reel 12, and thus at least partially in the direction of the flow of force.

The link 56 has a plurality of drilled holes, respectively one of which, together with a corresponding fixing screw that can be inserted into one of the drilled holes and screw-connected to the reel 12, serves as a fastening means 60 to enable the link 56 to be selectively fixed in various positions. Depending on which of the drilled holes is used to secure the link 56, the revolute joints 38 and a corresponding rotation of the eccentric drive 44 will produce a different swivel position of the reel tines 28.

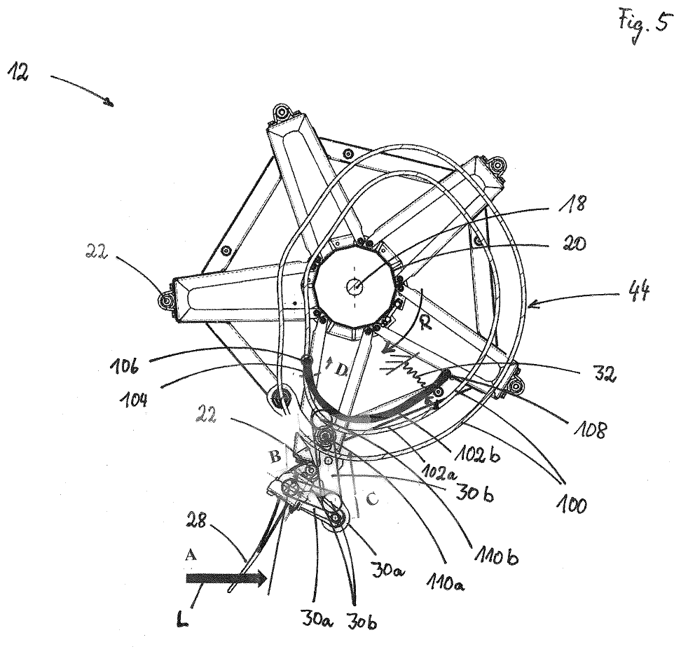

FIG. 5 shows a schematic side view of a second exemplary embodiment. The eccentric drive 44 has a slideway 100 in which a wall section 102 is mounted in a movable manner. The movably mounted wall section 102 of the slideway 100 is supported against the variable-length energy store 32. The movably mounted wall section 102 has a pivot bearing 106 at its rear end 104, as viewed in the direction of rotation R of the reel 12, and is supported at its front end 108 by the variable-length energy store 32.

The movably mounted wall section 102 is located in a section of the slideway 100 in which the slideway 100 guides the support elements 30, the tine carriers 22 of which, during a rotation motion of the reel 12, move in the region of what is the lowest position during a revolution. The support elements 30 are guided at a respective end 110 in the slideway 100. The movably mounted wall section 102 springs against the force of the variable-length energy store 32 in the direction of the longitudinal axis 18 of the reel 12. The support elements 30 are arranged so as to lag behind the tine carriers 22 in the direction of rotation R.

Represented in FIG. 5, for the second exemplary embodiment, is the sequence of motion of the relevant components that ensues in an overload situation. At position A, acting upon the reel tines 28, there is a load L, by which the reel tine 28 is pushed in the direction of the load L, by a rotation of the tine carrier 22 at position B, in the direction of the dashed arrow there. The load L causes the support element 30 to be displaced from position 30a to position 30b, along the arrow indicated at position C. The displacement motion of the support element 30 is possible because the end 110 of the support element 30 guided in the slideway 100 moves from the position 100a to the position 100b along the movably mounted wall section 102, which, under the action of the load L at position D., deflects inward with its rear end 108 along the dashed arrow indicated there, about the pivot bearing or swivel axis 106, against the force of the variable-length energy store 32. If the load L ceases, the movably mounted wall section 102 swivels back into the initial position 102a, driven by the restoring force of the variable-length energy store 32, as indicated by the double arrow.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements that are nearly ubiquitous within the art can replace or supplement any element identified by another reference character.

TABLE 1
List of Reference Characters

| | |
|---|---|
| 2 | Harvesting Appliance |
| 4 | Frame |
| 6 | Cutting Device |
| 8 | Conveyor Device |
| 10 | Transfer Interface |
| 12 | Reel |
| 12a | First Mutually Articulated Reel |
| 12b | Second Mutually Articulated Reel |
| 12c | Third Mutually Articulated Reel |
| 14 | Retaining arm |
| 16 | Drive Device |
| 18 | Longitudinal Axis of Reel |
| 20 | Carrying Body |
| 22 | Tine Carrier |
| 22a | Second Tine Carrier |
| 24 | Longitudinal Axis of Tine Carrier |
| 26 | Spoke Element |
| 28 | Reel Tine |
| 28a | Second Reel Tine |
| 28b | Third Reel Tine |
| 30 | Support Element(s) |
| 30a | First Position of Support Element |
| 30b | Second Position of Support Element |
| 32 | Energy Store(s) |
| 32a | Second Energy Store |
| 32b | Third Energy Store |
| 34 | Circle |
| 36 | Tab |
| 38 | Revolute Joint |
| 40 | Guide Element |
| 42 | Guide Link |
| 44 | Eccentric Drive |
| 46 | Frame Section |
| 46a | First Mutually Articulated Frame Section |
| 46b | Second Mutually Articulated Frame Section |
| 46c | Third Mutually Articulated Frame Section |
| 48 | Adjustment Range |
| 50 | Non-compression-Rigid Retaining Means |
| 50a | Second Non-compression-Rigid Retaining Means |
| 52 | First Point |
| 54 | Second Point |
| 56 | Link |
| 58 | Longitudinal Axis |
| 60 | Fastening Means |
| 100 | Slideway |
| 100a | First Position of Slideway |
| 100b | Second Position of Slideway |
| 102 | Movably Mounted Wall Section |
| 102a | Initial position of Mounted Wall Section |
| 104 | Rear End |
| 106 | Pivot Bearing |
| 108 | Front End |
| 110 | End of a Support Element Guided in the Slideway |
| A | First position |
| B | Second position |
| C | Third position |
| D | Fourth position |
| L | Acting Load |
| R | Direction of Rotation |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein, refers to slight variations in numerical quantities with respect to any quantifiable variable. An inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes a structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

What is claimed is:

1. A harvesting appliance (2) comprising of a frame (4), at least one cutting device (6) connected to the frame (4), a number of conveyor devices (8) and a transfer interface (10), one of the conveyor devices (8) is realized as a reel (12), which is connected to the frame (4) via height-adjustable retaining arms (14) and which can be driven in rotation about its longitudinal axis (18) via a drive device (16), the reel (12) has a central carrying body (20) that extends in a direction along the longitudinal axis (18) of the reel (12), the reel (12) additionally has a number of tine carriers (22), the longitudinal axes (24) of which extend in a direction along the longitudinal axis (18) of the reel (12) and parallel to the central carrying body (20) and which are arranged in a distributed manner on a circle (34) around the longitudinal axis (18) of the reel (12), the central carrying body (20) is connected to the tine carriers (22) via spoke elements (26) arranged at a distance from one another over the longitudinal axis (18) of the reel (12), mounted in a non-rotatable manner on each of the tine carriers (22), distributed over the length thereof, are a number of reel tines (28), and the tine carriers (22) are rotatably connected to the spoke elements (26), wherein each tine carrier (22) is held in a rotational position via a support element (30) assigned to the tine carrier (22), the support elements (30) are supported on an eccentric drive (44), which moves the support elements (30) during a full revolution of the reel (12) in the radial direction into different positions relative to the carrying body (20), and interposed between the eccentric drive (44) and a connection of a respective support element (30) to an associated tine carrier (22) there is variable-length energy store (32), which permits a yielding motion of the reel tines (28) when a load L is applied to the reel tines (28).

2. The harvesting appliance (2) according to claim 1, wherein the eccentric drive (44) has a slideway (100) in which the support elements (30) are guided at a respective end (110), a wall section (102) of the slideway (100) is mounted in a movable manner, and the movably mounted wall section (102) of the slideway (100) is supported against a variable-length energy store (32).

3. The harvesting appliance (2) according to claim 2, wherein the movably mounted section (102) has a pivot bearing (106) at its rear end (104), as viewed in the direction of rotation (R) of the reel (12), and is supported at its front end (108) by the variable-length energy store (32).

4. The harvesting appliance (2) according to claim 2, wherein the movably mounted wall section (102) is located in a section of the slideway (100) in which the slideway (100) guides the support elements (30), the tine carriers (22) of which, during a rotational motion of the reel (12), move in the region of what is the lowest position in the course of a revolution.

5. The harvesting appliance (2) according to claim 2, wherein the movably mounted wall section (102) deflects inward, against the force of the variable-length energy store (32) (32), in a radial direction toward the longitudinal axis (18) of the reel (12).

6. The harvesting appliance (2) according to claim 2, wherein the support elements (30) are arranged so as to lag behind the tine carriers (22) in the direction of rotation (R).

7. The harvesting appliance (2) according to claim 1, wherein interposed between the tine carrier (22) and the support element (30), there is a variable-length energy store (32), which permits a yielding motion of the reel tines (28) when a load is applied to the reel tines (28).

8. The harvesting appliance (2) according to claim 7, wherein the support elements (30) and energy store (32) are arranged at at least one end face of the reel (12).

9. The harvesting appliance (2) according to claim 7, wherein the tine carriers (22) are rotatably connected to the spoke elements (26) in that the tine carriers (22) are held non-rotatably on tabs (36), which in turn are each pivotably connected to the spoke elements (26) via a revolute joint (38), and an energy store (32) assigned to a tine carrier (22) is rotatably connected at least to a tab (36) of the assigned tine carrier (22), and optionally also to the support element (30) assigned to it, via revolute joints (38).

10. The harvesting appliance (2) according to claim 7, wherein the energy store (32) assigned to a tine carrier (22) is coupled, at its end that faces toward the tine carrier (22), to a guide element (40), the movability of which is positively guided by means of a guide link (42), and the tine carrier (22) is indirectly connected to the energy store (32), directly or indirectly only via a revolute joint (38), by means of the guide element (40).

11. The harvesting appliance (2) according to claim 10, wherein the guide link (42) is in the form of an eccentric drive (44).

12. The harvesting appliance (2) according to claim 10, wherein the guide link (42) is connected to a drive rod driven so as to move in a radial direction relative to the axis of rotation of the reel (12), and the end of the energy store (32) that faces away from the tine carrier (22) is fastened at a fixed position.

13. The harvesting appliance (2) according to claim 7, wherein the energy store (32) assigned to a tine carrier (22), is in the form of a leaf spring.

14. The harvesting appliance (2) according to claim 7, wherein the harvesting appliance (2) has a plurality of frame sections (46a, 46b, 46c) arranged next to one another and articulated to one another, and a plurality of reels (12a, 12b, 12c) arranged next to one another and articulated to one another, the reels (12a, 12b, 12c) being designed according to the features of the preceding claims.

15. The harvesting appliance (2) according to claim 7, wherein included for the function of the support element (30), there is a non-compression-rigid retaining means (50), which is connected to the variable-length energy store (32) at at least one first point (52), and is held in a fixed position at at least one second point (54) and, in its normal position, holds the variable-length energy store (50) under a preload.

16. The harvesting appliance (2) according to claim 15, wherein the guide link (42) is in the form of an eccentric drive (44), and a rotary motion between the eccentric drive (44) and a spoke element (26) is synchronized by means of a link (56) that connects the spoke element (26) and the eccentric drive (44) to one another in an articulated manner, the longitudinal axis (58) of the link (56) extending at least partially in the direction of rotation of the reel (12).

17. The harvesting appliance (2) according to claim 16, wherein the link (56) can be fixed in various positions via fastening means (60).

18. The harvesting appliance (2) according to claim 7, wherein the bending moments required to alter the shape of at least two reel tines (28) in the direction of rotation are greater than the moment of force required to alter the shape of the variable-length energy store (32).

19. The harvesting appliance (2) according to claim 7, wherein there are no separate means for overload protection between the reel tines (28) and the tine carriers (22).
